(19) United States
(12) Patent Application Publication
(10) Pub. No.: US 2018/0309585 A1
(43) Pub. Date: Oct. 25, 2018

(54) COMMUNICATION EXCHANGE FOR LOCAL DATA SERVICES

(71) Applicant: GLOBETOUCH, INC., Fremont, CA (US)

(72) Inventor: John Yue JIANG, Danville, CA (US)

(21) Appl. No.: 15/768,779

(22) PCT Filed: Oct. 21, 2016
(86) PCT No.: PCT/US16/58241

§ 371 Date: Apr. 16, 2018

Related U.S. Application Data
(60) Provisional application No. 62/244,566, filed on Oct. 21, 2015.

(51) Int. Cl. H04L 12/14; H04L 12/46; H04M 17/00; H04W 4/20; H04W 4/24; H04W 60/04; H04W 76/12

(52) U.S. Cl. CPC H04L 12/1475; H04L 12/1442; H04L 12/4641; H04M 17/208; H04W 88/16; H04W 4/24; H04W 60/04; H04W 76/12; H04W 4/20

(57) ABSTRACT

Aspects of the present invention are directed towards a system and method for facilitating local data service via communication exchange system where, within an ecosystem of one or more operators, a gateway is deployed by an operator for facilitating local data services for users that either the operator's local subscriber and inbound roamer. The gateway connects to the operators via VPN tunnel to facilitate local data services. The communication exchange also includes an interface that maintains a bi-directional connection with the gateway to exchange information related to roaming data services, and a bi-directional connection with users via their mobile devices' user interfaces.

### RELATED APPLICATIONS

This application claims priority from U.S. Provisional Patent Application 62/244,566 entitled “BORDERLESS GLOBAL DATA SERVICE (DATAZ),” filed on Oct. 21, 2015, which is incorporated herein by this reference in its entirety.

### FIELD OF THE INVENTION

The present invention generally relates to mobile communication. More specifically, the invention relates to enabling local data services while roaming.

### BACKGROUND OF THE INVENTION

Roaming traffic contributes a significant percentage of an operator's revenue and even a better percentage of the operator's margin. With increasing competition and regulatory control, operators are being more pressured to increase their roaming revenue. As the global mobile roaming market business model is evolving, the industry understands the strategic importance of roaming to operator's revenues and profit margins and is adapting various newly proposed regulations. The operators understand that they must develop strategies for driving the number of roamers and roaming usage, while lowering tariff rates. Mostly, the roaming revenue is contributed by voice calls based revenue and less revenue contribution is due to data services. Around 70% of global mobile data users do not use data services when on roaming. Hence, data roaming is currently underutilized by a factor of 25 times despite significant uptake with much reduced retail pricing and 10% increase of data roamers.

This situation would is exacerbated with the increasing adoption of smartphone and 4G technologies. Data roaming is still the primary source of customer complaints and comprehension as it is difficult to count volume of data usage on smartphone applications given the variety of the background running usage; while voice and messaging can be easily controlled and understood by the customers via CDRs.

Gone are the days when data usage used to be a luxury option. Now, it is a necessity of everyday use of mobile phone. In fact, it is the essence of keeping in touch these days given the popular adoption of social media platforms. It is also an increasingly important source of exchanging valuable information and conducting e-commerce.

In accordance with the foregoing, there is a need in the art of a system, a method, for creating a solution that gives an operator the ways to leverage the ecosystem of partnering operators to enable a user use data services for its local and inbound roamers, at competitive rates, with the aim of simplifying user's experience and maximizing roaming revenue for participating operators.

### SUMMARY

The present invention is directed towards a communication exchange system where within an ecosystem of one or more operators, a gateway is deployed by an operator for facilitating local data services for users that either the operator's local subscriber and inbound roamer. This gateway connects to the operators via VPN tunnel to facilitate local data services. The communication exchange also includes an interface that maintains a bi-directional connection with the gateway to exchange information related to roaming data services, and a bi-directional connection with users via their mobile devices' user interface.

The present invention is also directed towards a method for facilitating local data services for users of an operator who is part of an ecosystem of operators in a communication exchange system. The gateway receives a location update message of a user, who is either a local subscriber or an inbound roamer of the operator. The method further includes gateway establishing VPN tunnel over operators' data connection for the user to enable local data services, the local data services being enabled via an interface that maintains a bi-directional connection with the gateway and users' mobile devices' user interface.

### BRIEF DESCRIPTION OF DRAWINGS

In the drawings, the same or similar reference numbers identify similar elements or acts.

FIG. 1 illustrates a system for implementing communication exchange for local data service, in accordance with an aspect of the present invention;

FIG. 2 represents a flow diagram for implementing the communication exchange for local data services, in accordance with an aspect of the present invention;

FIG. 3 represents basic architecture for implementing the communication exchange for local data services, in accordance with an aspect of the present invention;

FIG. 4 represents charging model for the communication exchange for local data service, in accordance with an aspect of the present invention;

FIG. 5 represents network architecture of the communication exchange for local data services, in accordance with an aspect of the present invention;

FIG. 6 represents a flow diagram for implementing steering of roaming in the communication exchange, in accordance with an aspect of the present invention;

FIG. 7 represents an indicative user interface to configuring local data services on users' device, in accordance with a first aspect of the present invention; and

FIG. 8 represents an indicative user interface to configuring local data services on users' device, in accordance with a second aspect of the present invention.

### DETAILED DESCRIPTION

In the following description, for purposes of explanation, specific numbers, materials and configurations are set forth in order to provide a thorough understanding of the present invention. It will be apparent, however, to one having ordinary skill in the art that the present invention may be practiced without these specific details. In some instances, well-known features may be omitted or simplified, so as not to obscure the present invention. Furthermore, reference in the specification to “one aspect” or “an aspect” means that a particular feature, structure or characteristic, described in connection with the aspect, is included in at least one aspect of the present invention. The appearance of the phrase “in an aspect”, in various places in the specification, does not necessarily refer to the same aspect.

The present invention provides a system and a method for facilitating local data services for a user of a Home Public Mobile Network (HPMN) roaming in a Visited Public Mobile Network (VPMN). In accordance with various aspects, the present invention provides a method and system providing the user a facility to use data services even while roaming but charged at local rates.

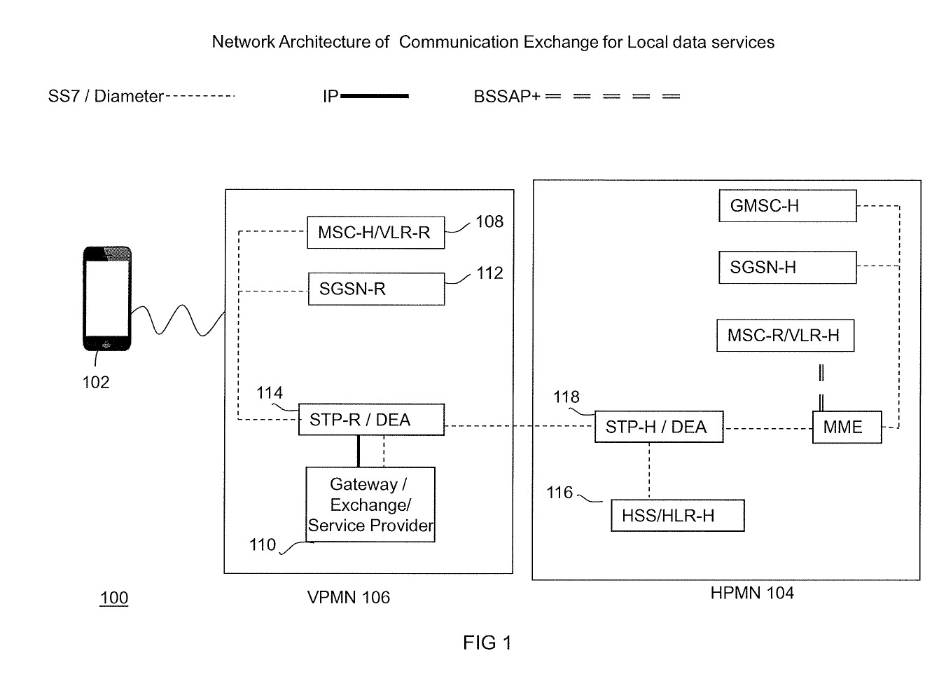

FIG. 1 illustrates a system 100 for facilitating the local data service for users, in accordance with an aspect of the present invention. A user 102 of HPMN 104 (from home country) is roaming in a VPMN 106 (from visiting country). The user 102 is connected to a VPMN VLR 108, when it is roaming outside HPMN 102. The system 100 includes a gateway 110, hereinafter, interchangeably referred to as communication exchange 110 or exchange 110 that facilitates local data services for user 102 while in VPMN 106, in accordance with various aspects of the present invention. In other aspects of the present invention, a local user of VPMN 106 is also benefiting from this present invention. The user 102 uses a smartphone device that has a provision to have a interface (e.g., a software application) that helps in maintaining a bi-directional connection with gateway 110 to exchange information related to the roaming services, and a bi-directional connection with user 102 via his/her mobile devices' user interface. For sake of representation only two operators (HPMN and VPMN) are shown, however, in various aspects of the present invention, exchange 110 works with an ecosystem that one or more operators (HPMNs and VPMNs), who would like their subscribers to use this facility of local data services. In further aspects, the scenario of only VPMN operators participating is also explained.

In one aspect of the invention, VPMN VLR 108 is connected with an SGSN-R 112, which is further connected with STP-R/DEA 114, via SS7 protocol. The exchange 110 is connected with STP-R/DEA 114 via IP in monitoring mode. User profile data corresponding to user 102 is stored in HPMN HLR-H 116. The signaling corresponding to user 102 is routed using STP-H 118. The signaling between HPMN 104 and VPMN 106 is carried using SS7 signaling architecture. The signals exchanged between HPMN 104 and VPMN 106 are MAP based signals.

For sake of representation, system 100 represents network elements from both LTE and GSM networks. HPMN 104 including HSS/HLR-H 116 connects via a STP-H/DEA 118 to an MME, which is further connected to an MSC-R/VLR-H in HPMN 104 via BSSAP+ protocol. These network elements communicate with each other over a Signaling System 7 (SS7) link.

It will also be apparent to a person skilled in the art that HPMN 104 and VPMN 108 may also include various other network components (not shown in FIG. 1), depending on the architecture under consideration. It will also be apparent to a person skilled in the art that various components of HPMN 104 communicate with VPMN 106 using various signaling techniques including, but not limited to, SS7, SIP, IP, ISUP etc.

In accordance with various aspects of the present invention, the exchange 110 is a B2B2C cloud-based electronic trading service that is built on an clearing exchange with an ecosystem of mobile operators (considered as merchants) that allows users such as user 102 through a software front end interface (without requiring them to change their mobile device and/or SIM) to sell and buy a local rate data package for use of a roaming or local device in a mobile operator of the ecosystem. In addition to cross operator trading between users of different networks, the users of a joining operator can even buy and sell local rate data packages in the same network. This electronic market place simplifies the user experience by enabling a pure smartphone (such as, but not limited to iOS based devices, Android based devices) application interface for the trading service.

In accordance with various aspects of the present invention, the exchange 110 provides a seamless experience to user 102. A roaming user or a local user with a smartphone (as defined above) with an unchanged HPMN 104's SIM using an application downloaded from an application store registers an account with the trading service, provided by exchange 110. Now, through this application, the user 102 can buy a local rate data package offered by a local mobile operator with a stored wallet or a payment method.

In accordance with several aspects of the present invention, the interface enables payments related to sale or purchase of data packages, using at least one of mobile wallet, PayPal, Credit Cards, Debit Card, wire transfers, NFC payments, WePay, Alipay, PayTM, and online payment systems. Once the user 102 has bought a data package, the data package can be activated on a scheduled time, on registration automatically or on demand manually. The user 102 may also manually select the mobile operator (via the application the application or via the user's mobile interface) or the user 102's phone is automatically steered to the desired mobile operator.

An enterprise service administrator (local or international) using the software interface (i.e., the application on user's mobile or a web interface or just a desktop client) registers an account with the trading service and can then buy an individual or group local rate data package on the trading platform for an individual or group of mobile devices (such as a company's employee group, M2M and Internet Of Things) the enterprise manages. Once a device is part of a bought package, the device's local usage can be activated on a scheduled time, on registration automatically or on demand remotely over the air. The device may also be configured for the selected mobile operator remotely over the air or be automatically steered to the mobile operator. Individual device's usage and monetary spending can also be controlled by the administrator.

In accordance with other aspect of the present invention, the exchange 110 provides a global online retail data service that is built on an ecosystem of participating mobile operators of heterogeneous radio technologies, via a smartphone application that requires no new SIM, no device change and no radio technology dependency. Thus, it allows subscribers of any operator of the ecosystem to buy, trade, share and use local rate data services across all ecosystem members who are data roaming partners of the operator in a borderless manner. It also provides a globally single point of connection for content and OTT sponsors to cover or reduce data costs of subscribers.

In accordance with various aspects of the present invention, the communication exchange 110 offering local data services is, hereinafter interchangeably, referred to as service provider 110 or gateway 110 or trading exchange 110 or DataZ service provider 110. In accordance with various aspects of the present invention, retail data pricing is governed by the service provider and not by any ecosystem of participating member operators. Although a member operator can also access an online portal to define just wholesale prices, the prices cannot be published to the end users. Only the service provider can publish the final price plans.

In accordance with various other aspects of the present invention, the communication exchange 110 allows users to trade their un-used data packages across operators of the ecosystem. For example, an ATT subscriber can trade/gift its unused data of a plan he bought on ATT network to a Verizon subscriber to be used in Verizon network, or even to a China Mobile subscriber to use in China Mobile network, assuming the mentioned 3 operators are participating operators of the ecosystem of the communication exchange 110. Since different operators of different countries might have different local rates of data volume, the service provide, i.e., communication exchange 110 masks out these differences with a common transferable price. It may also apply an exchange rate. For example, a 500 MB of ATT USA plan is equal to 100 MB of ViVo Brazil plan or 1 GB of Airtel India plan.

User 102 with a smartphone with an unchanged home operator SIM using an application on his smartphone registers an account with trading service of the service provider 110. Now through the application, user 102 can sell a portion of his unused local rate data package bought on the trading platform to another roaming traveler or a local user. The application informs the user how much data used so far and how much data is unused on its current data plan. Once the portion is sold, the user would be credited with the money in its stored wallet.

A mobile operator using the interface registers an account with the communication exchange 100/trading service, and can price and sell a local rate data package for one or more devices on the trading platform. Once the portion of package is sold, the operator account would be credited with the money in its stored wallet. The buyer could be a local user or a roaming user or local enterprise or international enterprise.

The present invention via its various aspects, allows the service provider to cater to its local and roaming users, where a local subscriber or a roamer (inbound or outbound) of a member operator can buy, trade, share and use on-demand or any other retail data service offering in any member operator as long as there is a data roaming relationship between the two member operators with the ecosystem. For example, an ATT subscriber who bought a data plan with the service provider 110 can use the same data plan on China Mobile network assuming both operators are members of the ecosystem and have data roaming relationship.

An enterprise service administrator using the interface registers an account with trading service 110 and can sell a portion of the enterprise's unused local rate data package bought on the trading platform. The software interface informs the administrator on usage of the data. Once the portion of data package is sold, the enterprise account would be credited with the money in its stored wallet. The buyer could be a local user or a roaming user or an enterprise.

It will be apparent to a person skilled in the art that the trading service 110 of local rate data plan can also be used by locals within the same operator or roaming devices between operators of national roaming and international roaming. Moreover, an operator merchant normally only sells data packages although there is no system restriction for the merchant to buy data packages as an enterprise too. However, non-operator merchant seller is restricted to sell only data packages that are bought via the trading service.

In accordance with various other aspects, the present invention offers a global wireless Wifi service to its users, where the user when he/she does not have a local cellular data service, he/she can use WiFi for free (as long as they downloaded the software application and get on the partner networks hotspots via the software application.

In accordance with various aspects of the present invention, the service provider/communication exchange 110/gateway 110, provides local data service using VPN tunnels to participating operators without change user's SIM. In order to do so, service provider 110 uses operators' GGSN and PGWs instead of routing to through HPMN 104 and thus has no billing settlement with HPMN 104.

This allows service provider 110 to use VPN technology to beyond mere data cost reduction via compression like in Facebook etc. The primary focus of service provider 110 is to allow using, trading and sharing retail data offerings across an ecosystem of mobile operators, rather than just one operator. Specifically, unlike existing sponsored data solutions where one has to negotiate sponsorships on a per operator basis, in the present invention, sponsorship can be applied across the whole ecosystem with a single connection. As the ecosystem grows, sponsorship grows with it.

The software interface (i.e. the smartphone application) on user 102's handset, sets up a generic VPN for users' internet service across all applications (e.g. Uber or browser) on the phone. This approach differs from some sponsored apps like Uber which only apply free rate to specific sponsorship application (e.g. Uber). The advantage of using this approach via Service provide 110 is that there is no need for any software application change for sponsorship as there is a DPI (Deep Packet Inspection) in VPN cloud side to differentiate the sponsored application from normal internet access. The only pre-requisite is that user 102 has to download this software application once.

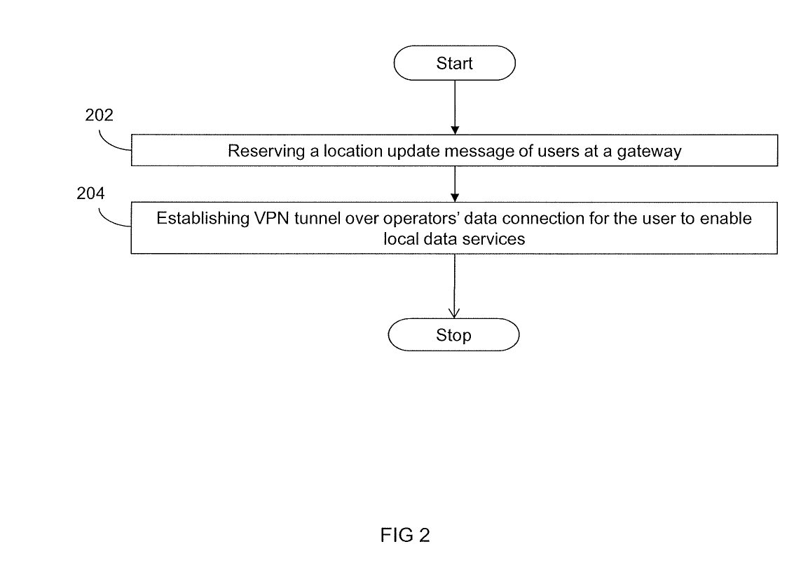

FIG. 2 represents a flowchart for implementing the communication exchange for local data service, in accordance with an aspect of the present invention. At step 202, gateway 110 receives a location update message of user 102. The user 102 is inbound roamer of VPMN 106. Thereafter, at step 204, the gateway 110 establishes VPN tunnel over VPMN operators' 106 data connection for user 102 to enable local data services. The local data services are provisioned via a user interface that could be a smartphone application that maintains a bi-directional connection with the gateway 110 and users 102′ mobile devices' user interface.

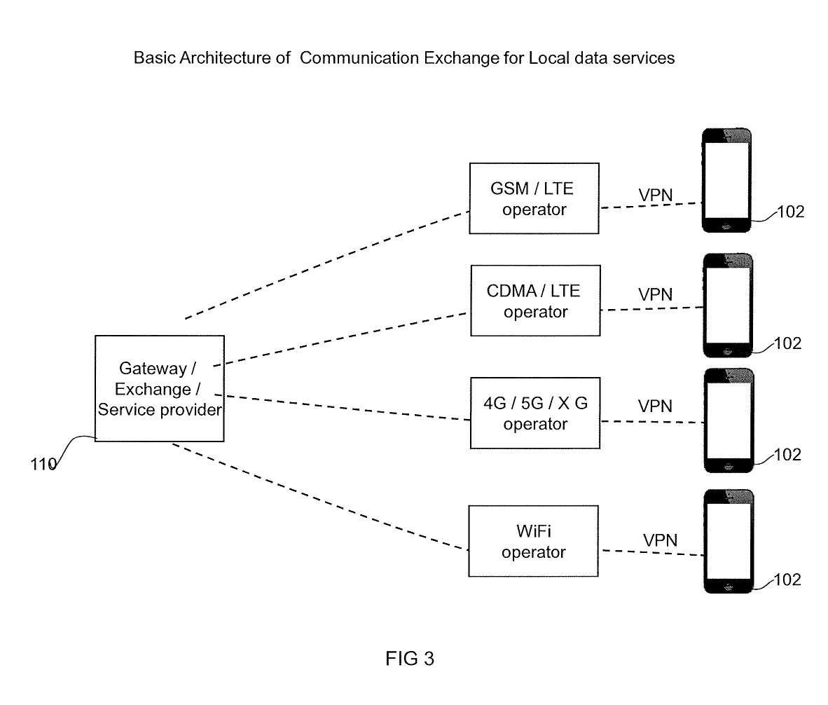

FIG. 3 represents basic architecture for implementing the communication exchange for local data services. The basic architecture includes a cloud based service provider 110 connected to the ecosystem of mobile operators via VPN tunnels. User 102's smartphone application when enabled with a VPN, allows an end to end secure connection from the smartphone to service provider 110's cloud. The member operator can be one of the radio access technologies, including but not limited to, GSM, 3GSM, LTE, CDMA, 4G, 5G, Wifi, Wimax or any local area or wide area technologies. The communication exchange 100 ensures that not just the subscribers of the operators of ecosystem can enjoy the local data service but also any inbound roamers to a member operator can also enjoy the local data service at the operator.

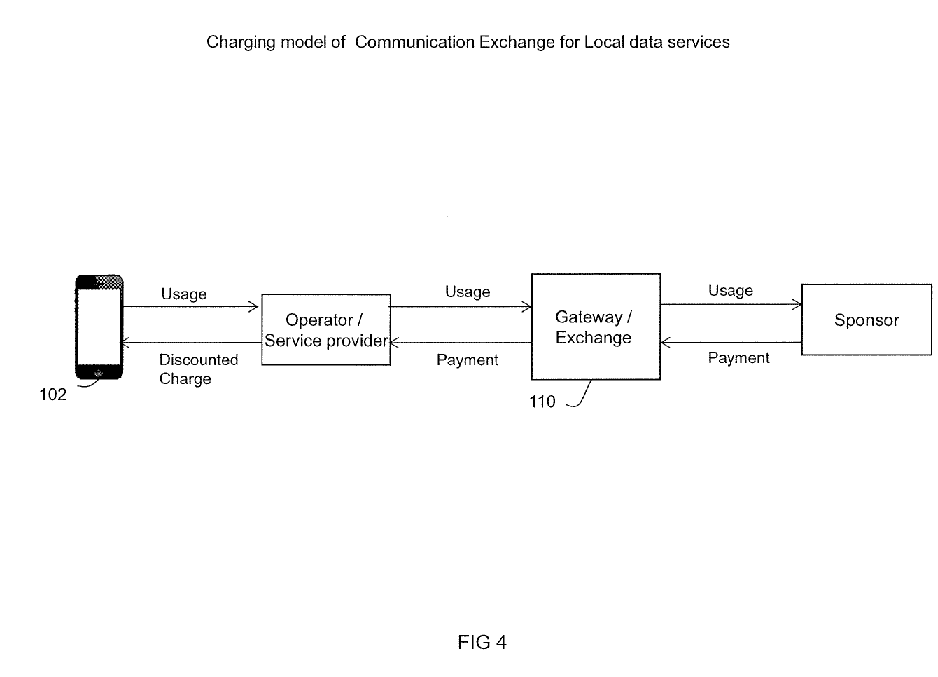

FIG. 4 represents charging model for the communication exchange for local data service, in accordance with an aspect of the present invention. The communication exchange 100's service provider 110 offers free or discounted local rate charged data usage to its users via sponsorship over the VPN channel. The member operators waive off charges to the users and instead charge the service provider 110 which has a direct retail or charging relationship with the users directly. In case of sponsored usage (such as Uber or Facebook), the service provider 110 will charge the sponsors rather than the users. The user 102's smartphone application usually has a payment account (e.g. credit card, debit card, paypal, Alipay, unionpay, ApplePay etc.) which can also be a corporate payment account which can pay and receive financial value on the local data services offered by service provider 110.

In accordance with yet another aspect of the present invention, the service provider 110 offers a network independent online store through a discounted or free charging via advertising or OTT sponsors, or a better bundle data pricing and further allows trading, sharing and other value added services. Some of these commonly known value-added services are, but not limited to:
1) Transaction based charging, e.g. a movie
2) Media storage in the cloud
3) On-demand data bundle
4) Self-configurable bundle by subscribers
5) Auction of unused data
6) Roll-over of unused data
7) VOIP and instant messaging services
8) Video/voice conference and recording
9) Call hand-off across member operators (including Wifi, cellular, CDMA, GSM, LTE, 3G, etc.)
10) Compression to reduce data cost and improve its speed
11) Transaction logs or content storage in the Service provider's cloud

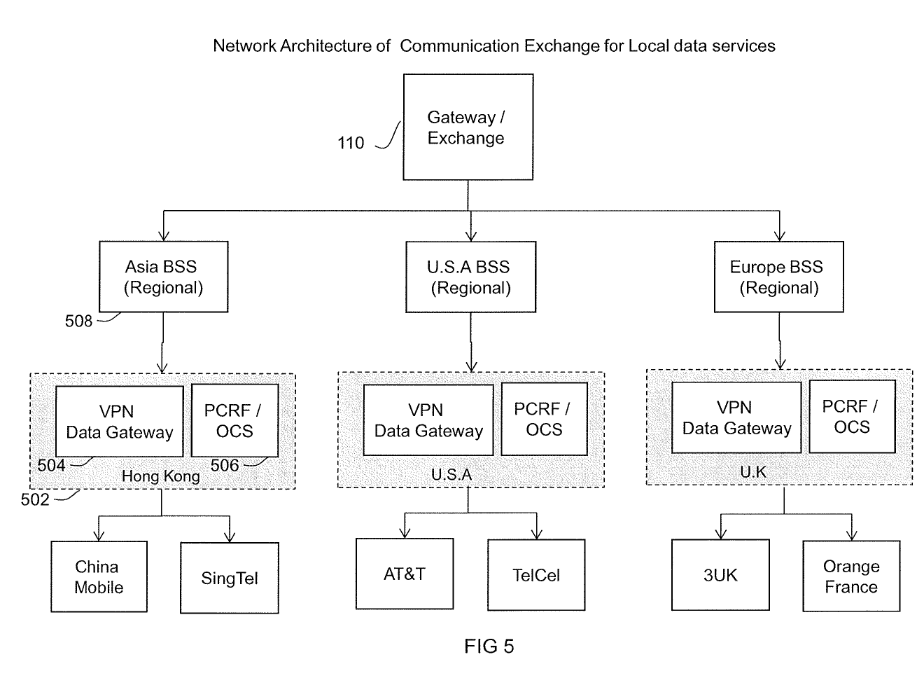

The service provider 110 cloud system architecture has a hierarchical level of distributed elements that interact to provide this local data services. FIG. 5 represents network architecture of the communication exchange for local data services, in accordance with an aspect of the present invention. At the leaf level nodes in the architecture, there are distributed edge nodes around the world. E.g node 502 in HongKong. Each edge node consists of a VPN data control gateway 504 with DPI (Deep Packet Inspection) capability and Internet access with prepaid online charging system (OCS) and PCRF 506 (Policy Charging Function). The edge node can be deployed at country level or regional level close to the member operators (to reduce latency).

In accordance with various aspects of the present invention, the VPN data gateway 504 is also the local breakout gateway of the service provider 110. It would be apparent to a person skilled in the art that the VPN data gateway 504 could also be different from the local breakout gateway which can be the operator's GGSN/PGW. The OCS and PCRF 506 stays close to the VPN data control gateway 504 to allow data session to continue with transient records stored locally even though communication with upper level of communication exchange system is lost. Once the communication is recovered, the transient records can be pushed back to the upper level of the communication exchange system.

At next level, there is a regional or continental BSS 508 (Business Support System). E.g. in FIG. 5, Asia, Europe, U.S.A BSS are show, which deals with subscriber profiles, balance, transaction records, billing information, bundles, service offers (to others and to themselves). Each subscriber has a home BSS close to his SIM subscription operator. When subscribers use services outside their “home”, e.g. roaming to a member operator, the relevant “home” BSS information of the subscriber would be transferred temporarily to the “roaming” BSS of the serving member operator.

At the next level, there is a central online store on which the service provider 110 puts its service offering on member operators to buy, trade, share and use those service offerings. This central online store is geographically independent. The smartphone application on user 102's handset accesses the online store to present a market place of local rate plans offered on different operators. To use a plan at a member operator, the user must select the member operator for registration.

The VPN control cloud and the online operator portal in this patent application allows a member operator to define wholesale price to service provider 110 and does not allow a member operator to publish price to end users as the communication exchange service controls the retail price to the end users.

In accordance with various aspects of the present invention, in order to handle roaming users, the subscriber's data access is locally routed via a member operator rather than to its home operator (i.e., SIM subscription). This routing can be handled either by changing APN or not.

In accordance with various aspects of the present invention, the APN change solution involves the user 102's smartphone application to use a new APN, say APN-Z, which can be set automatically by OEM partnership of smartphone vendors (e.g. Samsung, Xiaomi, Huawei) or smartphone OS providers (e.g. iOS, Android or Windows). Alternatively, this new APN-Z can be set by guidance of the application e.g. via some profile installment. In this APN change approach there is a dynamic profile change to insert the new APN-Z when the subscriber is roaming at the roaming member operator (e.g. VPMN 106). On the network side, a member operator dynamically adds the APN-Z to a user registered on the network with an additional marker.

In accordance with another aspect of the present invention, in no APN change solution approach, there is no need for smartphone to do anything on APN. Just on the network side, the member operator will dynamically add a new marker to the profile of the user registered on the network. This marker can be VPAA flag or a special APN-OI replacement indicating the service provider 110 so the user 102's data DNS is configured alternatively from the home operator (i.e. HPMN 104). The member operator is able to waive the charge of data usage on individual user based on the APN-Z or VPAA flag or VPN IP address and charge them instead to the service provider 110.

In accordance with various aspects of the present invention, since there is an additional VPN tunnel, there is no need for APN change for on demand local data service at a member operator when the user is a subscriber of the operator. Likewise, there is also no need for the non-APN change approach for local subscribers of a member operator to use data service at the member operator. When the smartphone application sets up a VPN tunnel, it chooses a VPN data control gateway based on the IP address or location of the user's device when on a member network of the ecosystem. This is done either via by having a local database in the smartphone application of member network and VPN gateway IP address. Alternatively there could be a default VPN gateway IP address when a member network is not in the local database of the smartphone application. Hence, this can be used to bootstrap to load the new VPN gateway IP address for the member network to start a new VPN connection with the new VPN gateway IP address.

In order to more clearly explain all aspects, following few uses cases are used. The telecom company (e.g., Globetouch) signs up AT&T as its ecosystem partner. AT&T waives the charges to end users on its cellular data connection for usage on its VPN tunnel. Now Globetouch offers end users a price plan on the local data usage on AT&T. Globetouch charges its end users or sponsors or both. GlobeTouch may then share the revenue with AT&T. For a local subscriber of AT&T, the smartphone application sets up a VPN tunnel over the AT&T subscriber's cellular data connection. For an inbound roamer of AT&T, the smartphone application first sets up a local breakout connection which would involve both AT&T serving gateway (SGSN) and AT&T (GGSN) packet gateway. It then sets up a VPN tunnel over the local breakout connection.

In another use case scenario, Globetouch signs up China Mobile as its partner. Then China Mobile waives the charges to end users on its cellular data connection for usage on its VPN tunnel. GlobeTouch offers its end users a price plan on the data usage on China Mobile. Globetouch then charges its end users or sponsors or both. GlobeTouch may share the revenue with China Mobile. For a local subscriber of China Mobile, the smartphone application sets up a VPN tunnel over the China Mobile subscriber's cellular data connection. For an inbound roamer of China Mobile, the smartphone application first sets up a local breakout connection which would involve both China Mobile serving gateway (SGSN) and China Mobile (GGSN) packet gateway. It then sets up a VPN tunnel over the local breakout connection. In case user already has a balance on an AT&T price plan he bought before, the user can still use the balance against the usage in China Mobile network over the VPN connection.

In yet another use case scenario, Vodafone India is not a partner of Globetouch in its ecosystem. Therefore, any user (local sub or inbound roamer) can still use the Globetouch smartphone application. But in this case, application only helps reduce and secure data usage through encryption/compression. Basically Vodafone does not waive the charges to its end users on its cellular data connection for usage on this VPN tunnel. Hence, GlobeTouch cannot offer end users a price plan on the data usage on Vodafone, although it could still charge users for the VPN tunnel service. Globetouch will not be able to share revenue with Vodafone since there is no special partnership.

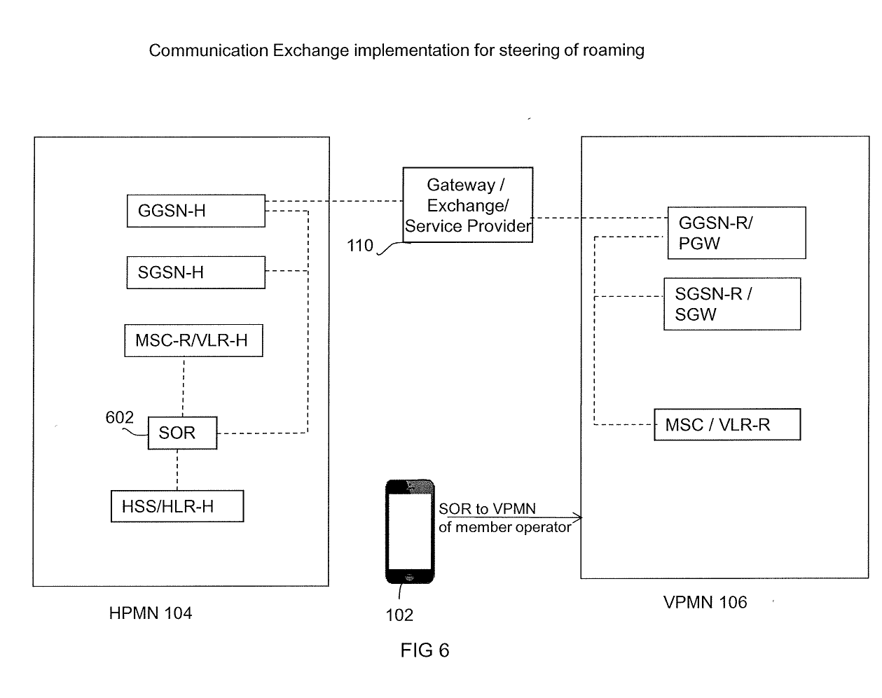

FIG. 6 represents a flow diagram for implementing steering of roaming in the communication exchange, in accordance with an aspect of the present invention. The steering function in the home member operator HPMN 104 of user 102 can help direct the roamer to the member operator to avoid the user manually select the visiting member operator VPMN 106. Each participating operator has a network steering system based on dynamic class of subscribers. In accordance with an aspect of the present invention, there is a secure IP connection between communication exchange system's cloud and the operator. Whenever the subscriber of exchange enables local data service, the operator of subscriber 102 will put the subscriber into the class of subscribers where traffic steering module SOR 602 will only direct network selection on member operators with any preference strategy the operator defines, whenever there are multiple member operators in a destination, including both international and national roaming situations. For example, assuming China Mobile and China Unicorn, ATT and Tmobile are participating operators, ATT can direct local data service enabled subscribers of its SIM subscription to China Unicorn if they roam into China and China Unicorn is the preferred operator to China Mobile. The ATT and Tmobile has national roaming, Tmobile can direct local data enabled subscribers of its SIM subscription to its own network if they roam in USA, unless ATT is the only one that has coverage in that spot.

In accordance with various other aspects of the present invention, the local data services can also be extended to provision a global WiFi service. In such cases, the user 102 can be restricted to use the WiFi service with an activated plan at a country only or at any country in the ecosystem. The user 102 can also use the WiFi service in any country in the world (beyond the ecosystem) to attract more downloads of the smartphone application before the ecosystem has enough coverage. Since the local data plan can be transferred to any member operator, the WiFi service can always be used in any member operator of the ecosystem.

In accordance with various aspects of the present invention, user 102 has multiple mobile accounts and trade (buys or sells) data packages on the currently activated account (or default account). For each account, user 102 can also configure threshold alert, remaining balance alert, top up alert etc. However, each mobile account must be verified at the time of registration via the corresponding SIM as HPMN 104 of user 102 needs to have a roaming relationship with VPMN 106. If this is not verified, and HPMN 104 is based on user 102's entry at the registration which is wrongly input, then if the data package of VPMN 106 bought at trading service 100 cannot be used due to no-roaming agreement, the liability would be on user 102 although user 102 could still sell the data package.

In accordance with another aspect of the present invention, user 102 may also buy or sell data packages for its own use and might require administrator approval, depending on the enterprise policy. For example, an enterprise might have a group plan for US AT&T, but an individual employee might need to go to South Africa and buys a local data package there but need to be approved by the company.

The user 102 may receive notifications for data usage alerts, sale expired alerts, top up or switch back home data routing alerts etc. via email, web notification box, or smartphone app/interface. The interface can also store and update usage of each purchase plan locally. Whenever there is a country change or network change, the interface can verify if there is a local package or still unused for the country. If there is, but the registered operator is not the local operator of the package, then the interface can alert user 102 to do a manual switch to package VPMN 104.

It will be apparent to person skilled in the art that when the interface is manually switching to the operator network with a bought local rate data package, HPMN 104's steering system will be overwritten. Based on the GSMA guidelines BA 30 and IR 73, user 102's manual selection must be honored and overwrite steering preferences. As mentioned in earlier aspects, if VPMN 106 is forbidden or no roaming relationship, it would not be presented to user 102 in the market place for trading of data packages. Upon returning home or country where there is no visiting country data package balance available, the interface can be alerted to manually or automatically switch back to the HPMN (e.g. APN-Z) profile.

In accordance with an aspect of the present invention, in order to implement this trading exchange, HPMN operators are also part of the operators' ecosystem. There are several ways in HPMN operator can support this trading exchange. In one such aspect, HPMN 104 provides a USSD interface for menu selection for its subscribers (i.e. user 102) already outside the country or simply just for own subscribers making a purchase of data packages without incurring data (or data roaming) charges. HPMN 104 defines HPMN USSD service code at HLR-H 116 and a USSD gateway. There is an IP interface between USSD Gateway and Exchange Service/Gateway 110. HPMN 104 provides to the interface with subscriber HPMN network, MSISDN, visiting network etc. and gateway 110 presents a corresponding menu dynamically based on the user 102's HPMN network and the visiting country (based on VPMN 106). Similar concept to USSD, SMS channel can also be used. However, due to speed impediment in using SMS and still incurring roaming cost, the aspects of the present invention may be implemented using SMS, in some situations.

It will be apparent to a person skilled in the art that the trading exchange is not operating as a MVNO model but as simply an electronic retail distribution model for operators tailored for locals, travelers and enterprises without a new SIM for user 102. This service provider has a direct retail relationship with subscribers of participating member operators of the ecosystem. The retail service provides a single point of contact for all sponsoring service and for customer relationship. It is unique in industry because it allows a global and flat retail offering across all member operators including roaming situations.

Although, it is trading local rate data service, it does not offer customer care to end user communication service. This is very similar to other trading exchanges like eBay, Priceline, selling car rentals/hotels where these trading services do not provide customer care for the hotel or car service. As a result, the customer care for end user communication service is still with the serving or home mobile operator. This is similar to car rental bought through Priceline where car service is still a responsibility of the car rental company.

Notwithstanding, exchange 110 has its own customer care for handling complaints about the trading service rendered by mobile operator at exchange 110, similar to customer care in Priceline or Hotel.com. As the users and merchants' financial transactions are going through the exchange 110 as a broker, similar to issuing/acquiring banks of credit cards for charge backs, the trading service would also handle refunds in case the user service is not rendered for the paid packages. In the case, the refund is cascaded as well. The trading service would refund the users and the operators/merchants would need to refund the trading service including all transaction fees.

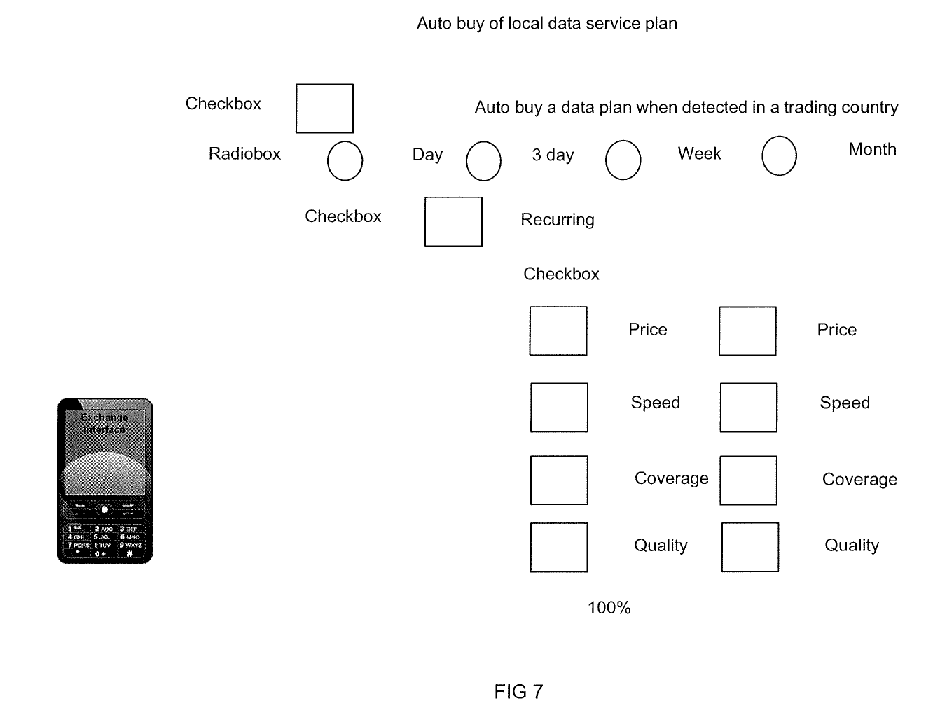

In accordance with various aspects of the present invention, the trading exchange can also be extended to automatically select a data plan and sells an unused plan for a subscriber should he opt-in so based on the criteria he sets. In accordance with one such aspect of the present invention, FIG. 7 represents an indicative user interface to configuring an auto-buy of local data services on users' device. To automatically buy a plan, user 102 may preset a day-plan, 3-day-plan, a week plan, or a month plan. He can also define criteria based on coverage, speed, price and quality either based on simple checkbox or based on a percentage weight in total of 100%. There is also a recurring option for user 102 to check so that if the current plan is finished and the subscriber is still in the country.

This automation is triggered by the software interface detecting user 102 is registered in a network in a country that trades data plan in the trading exchange. Then the software interface can communicate with the trading exchange via USSD or WiFi to avoid incur roaming charge. When the current plan is used up or about to be used up, the trading exchange would inform the software interface via SMS or data channel of the bought data package. If the software interface detects the user 102 is still registered in the country, and the software interface informs the trading exchange via USSD or WiFi to avoid incur roaming charge. If user 102 has opted in for the recurring option, another plan would be bought.

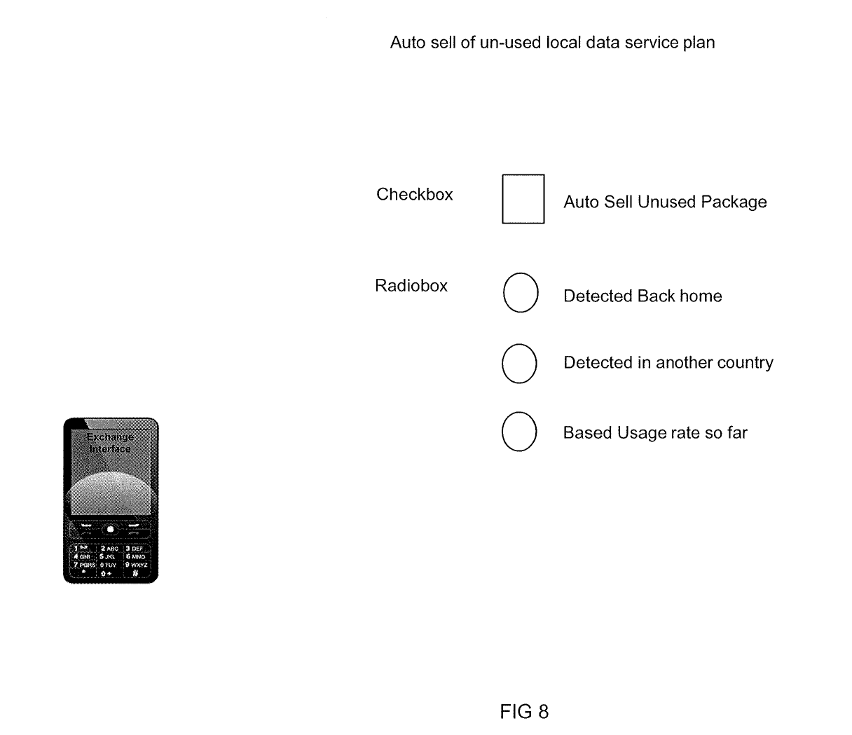

FIG. 8 represents an indicative user interface to configuring an auto-sell of local data services on users' device, in accordance with an aspect of the present invention. To automatically sell an unused plan, user 102 sets the condition based on detection of him reaching home or another country or just based on his currently daily usage rate to sell unused data package. The price would be defined by the trading exchange 110 to the best of its capability. The automation is triggered by software interface detecting user 102's mobile is registered in a network in a home or another country or based on the daily usage rate at the trading place.

In accordance with various aspects of the present invention, the exchange 110 manages a wallet account for each registered user similar to Paypal or Amazon Payment due to transactional funds similar to Ebay or Paypal. Like the Paypal the account could be backed up by credit card or bank transfer automatically when the balance is running out. Also like the Paypal, the balance could be cashed out directly via a bank card or transfer back to a bank account.

In accordance with several other aspects of the present invention, the trading exchange can also be extended to auctioning of data packages, similar to Priceline or Ebay. The present invention allows user 102 to be a seller other than an operator, the auction allows the following possibilities:

a) The buyer can name own price

b) The buyer can bid for a deal

c) The seller can provide an optional minimum price and an optional definite sell price for buyers to bid (within a bid period)

d) The seller can just present a non-negotiable pricing

e) There can be multiple operators' offering to choose.

However, the auction extension in the non-operator merchant seller case continues to be restricted to packages bought via the trading exchange.

In accordance with an aspect of the present invention, the data package bought could be application based charging. For example, only Facebook is free with the bought data package. Or the data package would be unlimited for the fixed price but with speed downgraded to 2G. VPMN 106 could also allow a URL access for free for the trading exchange 110. This will be automatically updated into the software interface for accessing the store front when the user 102's device is accessing the network.

In another aspect of the present invention, the trading exchange can be extended to support VoIP by offering multiple number VoIP service where a member mobile operator of the ecosystem can contribute a local number for roamers or non-member customers to permanently or temporarily use for making or receiving calls and SMS. Moreover, the trading exchange can bind incoming calls to a user's number of the member mobile operator over IP to reduce roaming cost.

It yet another aspect of the present invention, a travel enterprise (e.g. airline, hotels, tourist business including shopping and restaurants etc.) software application is built on the trading exchange API so that the cost on the usage of user 102 on the software application in roaming or local environment including VoIP calls can be covered by the enterprise for the trading exchange. In this case, the enterprise does the B2C advertising and own services including free or sponsored data roaming and VoIP calls. The enterprise also does cross advertising and B2B trading among related enterprise on the exchange, for example, Chase Bank advertise on Nike App, hotels on airline apps, car rentals on hotels etc. In a continued aspect of the present invention, OTT apps such as Skype, Facebook, WhatsApp, Google voice etc. are built on the trading exchange to leverage a sponsored data plan in return for advertising revenue. Moreover, all the buyers' traveling destinations, data usage statistics, buying expense etc., and all the sellers' unused data amount statistics and selling operators etc. provide valuable analytics for advertising, traveling enterprise apps and targeted marketing of further trades.

In other aspect of the present invention, the trading exchange tracks and report application protocols and URLs etc. based on DPI support of VPMN 106. In particular, VPMN 106 provides foot fall data intelligence on travelers, while the trading exchange provides travelers profiles around the world. The combined profile allows traveling enterprises to form targeted advertising on different enterprise applications. If HPMN 104 also participates, more subscriber profile data (on local usage and worldwide roaming usage) is used for better targeted advertising.

In yet another aspect of the present invention, since the trading exchange operates based on MSISDN, number portability works when changing operators except when the new operator has no roaming relationships with the visiting operator of the bought package. User 102 still will be liable for payment in this exceptional case, similar to no-show cancellation on non-refund, e.g. trip cancelled. However, unlike no-show cancellation policy, user 102 can sell the unused package to other users through the trading exchange. If user 102 changes numbers either on existing or new operators or the user 102 intends to use another SIM, user 102 will still be liable for the payment. However, user 102 can transfer the data package on its new number without incurring any charges. User 102 can also sell it but that would incur additional charges.

In accordance to another aspect, the number portability feature is used to implement gifting. Unlike number change, the gifting might not verify the gifted party's number although to avoid mistakes, it is recommended to verify it. The software interface manages multiple SIMs accounts to allow user 102 to swap SIMs, as the software interface can switch accounts as buyers and sellers for the correspond SIMs. However, each SIM can only have one account, verified at the time of registration. Once registered, user 102 is free to use the trading service using any SIMs as it can switch accounts on line for trading data packages on the selected account.

In accordance with yet another aspect of the present invention, the gateway 110 facilitates local data roaming for users using multi-IMSI SIM. The new multi-IMSI SIM has several static IMSIs based on partnership between operators.

It will be apparent to a person skilled in the art, that the present invention can also be applied to Code Division Multiple Access (CDMA)/American National Standards Institute #41D (ANSI-41D), and various other technologies such as, but not limited to, VoIP, WiFi, 3GSM and inter-standard roaming. In one exemplary case, a CDMA outbound roamer travels with an HPMN CDMA handset. In another exemplary case, the CDMA outbound roamer travels with an HPMN GSM SIM and a GSM handset. In yet another exemplary case, GSM outbound roamer travels with an HPMN CDMA RUIM and a CDMA handset. To support these variations, system 100 will have a separate SS7 and network interfaces, corresponding to both the HPMN and VPMN networks. It will also be apparent to a person skilled in the art that these two interfaces in different directions may not have to be the same technologies. Moreover, there could be multiple types of interface in both directions.

An exemplary list of the mapping between GSM MAP and ANSI-41D is described in the table below as a reference.

| GSM MAP | ANSI-41D |
|---|---|
| Location Update/ISD | REGNOT |
| Cancel Location | REGCAN |
| RegisterSS | FEATUREREQUEST |
| InterrogateSS | FEATUREREQUEST |
| SRI-SM | SMSREQ |
| SRI | LOCATION REQUEST |
| ForwardSMS | SMSDPP |
| ReadyForSMS | SMSNOTIFICATION |
| AlertServiceCenter | SMSNOTIFICATION |
| ReportSMSDelivery | SMDPP |
| ProvideRoamingNumber | ROUTING REQUEST |

The present invention can take the form of an entirely hardware aspect, an entirely software aspect, or an aspect containing both hardware and software elements. In accordance with an aspect of the present invention, software, including but not limited to, firmware, resident software, and microcode, implements the invention.

Furthermore, the invention can take the form of a computer program product, accessible from a computer-usable or computer-readable medium providing program code for use by, or in connection with, a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CDROM), compact disk-read/write (CD-R/W) and Digital Versatile Disk (DVD).

The components of present system described above include any combination of computing components and devices operating together. The components of the present system can also be components or subsystems within a larger computer system or network. The present system components can also be coupled with any number of other components (not shown), such as other buses, controllers, memory devices, and data input/output devices, in any number of combinations. In addition, any number or combination of other processor-based components may be carrying out the functions of the present system.

It should be noted that the various components disclosed herein may be described using computer aided design tools and/or expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but may not be limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, it covers all of the following interpretations: any of the items in the list, all of the items in the list and any combination of the items in the list.

The above description of illustrated aspects of the present system is not intended to be exhaustive or to limit the present system to the precise form disclosed. While specific aspects of, and examples for, the present system are described herein for illustrative purposes, various equivalent modifications are possible within the scope of the present system, as those skilled in the art will recognize. The teachings of the present system provided herein can be applied to other processing systems and methods. They may not be limited to the systems and methods described above.

The elements and acts of the various aspects described above can be combined to provide further aspects. These and other changes can be made in light of the above detailed description.

### Other Variations

Provided above for the edification of those of ordinary skill in the art, and not as a limitation on the scope of the invention, are detailed illustrations of a scheme for proactive roaming tests, discoveries of roaming partner services and discoveries of frauds in roaming using simulated roaming traffic. Numerous variations and modifications within the spirit of the present invention will of course occur to those of ordinary skill in the art in view of the aspects that have been disclosed. For example, the present invention is implemented primarily from the point of view of GSM mobile networks as described in the aspects. However, the present invention may also be effectively implemented on GPRS, 3G, CDMA, WCDMA, WiMax etc., or any other network of common carrier telecommunications in which end users are normally configured to operate within a “home” network to which they normally subscribe, but have the capability of also operating on other neighboring networks, which may even be across international borders.

The examples under the system of present invention detailed in the illustrative examples contained herein are described using terms and constructs drawn largely from GSM mobile telephony infrastructure. However, use of these examples should not be interpreted as limiting the invention to those media. The system and method can be of use and provided through any type of telecommunications medium, including without limitation: (i) any mobile telephony network including without limitation GSM, 3GSM, 3G, CDMA, WCDMA or GPRS, satellite phones or other mobile telephone networks or systems; (ii) any so-called WiFi apparatus normally used in a home or subscribed network, but also configured for use on a visited or non-home or non-accustomed network, including apparatus not dedicated to telecommunications such as personal computers, Palm-type or Windows Mobile devices; (iii) an entertainment console platform such as Sony Playstation, PSP or other apparatus that are capable of sending and receiving telecommunications over home or non-home networks, or even (iv) fixed-line devices made for receiving communications, but capable of deployment in numerous locations while preserving a persistent user id such as the eye2eye devices from Dlink; or telecommunications equipment meant for voice over IP communications such as those provided by Vonage or Packet8.

In describing certain aspects of the system under the present invention, this specification follows the path of a telecommunications call, from a calling party to a called party. For the avoidance of doubt, such a call can be a normal voice call, in which the user telecommunications equipment is also capable of visual, audiovisual or motion-picture display. Alternatively, those devices or calls can be for text, video, pictures or other communicated data.

In the foregoing specification, specific aspects of the present invention have been described. However, one of ordinary skill in the art will appreciate that various modifications and changes can be made without departing from the scope of the present invention as set forth in the claims below. Accordingly, the specification and the figures are to be regarded in an illustrative rather than a restrictive sense, and all such modifications are intended to be included within the scope of present invention. The benefits, advantages, solutions to problems, and any element(s) that may cause any benefit, advantage, or solution to occur, or to become more pronounced, are not to be construed as a critical, required, or essential feature or element of any or all of the claims.

APPENDIX

| Acronym | Description |
|---|---|
| 3G | Third generation of mobile |
| ACM | ISUP Address Completion Message |
| ANM | ISUP Answer Message |
| ANSI-41 | American National Standards Institute #41 |
| ATI | Any Time Interrogation |
| BCSM | Basic Call State Model |
| BSC | Base Station Controller |
| BOIC | Barring Outgoing International Calls |
| BOIC-EX- | Barring Outgoing International Calls except to home |
| Home | country |
| CAMEL | Customized Application for Mobile Enhanced Logic |
| CAP | Camel Application Part |
| CB | Call Barring |
| CC | Country Code |
| CDMA | Code Division Multiplexed Access |
| CdPA | Called Party Address |
| CDR | Call Detail Record |
| CF | Call Forwarding |
| CgPA | Calling Party Address |
| CIC | Circuit Identification Code |
| CLI | Calling Line Identification |
| CSD | Circuit Switched Data |
| CSI | Camel Subscription Information |
| DPC | Destination Point Code |
| DSD | Delete User Data |
| DTMF | Dual Tone Multi-Frequency |
| ERB | CAP Event Report Basic call state model |
| EU | European Union |
| FPMN | Friendly Public Mobile Network |
| FTN | Forward-To-Number |
| GLR | Gateway Location Register |
| GGSN | Gateway GPRS Support Node |
| GMSC | Gateway MSC |
| GMSC-F | GMSC in FPMN |
| GMSC-H | GMSC in HPMN |
| GPRS | General Packet Radio System |
| GSM | Global System for Mobile |
| GSMA | GSM Association |
| GSM SSF | GSM Service Switching Function |
| GsmSCF | GSM Service Control Function |
| GT | Global Title |
| GTP | GPRS Tunnel Protocol |
| HLR | Home Location Register |
| HPMN | Home Public Mobile Network |
| IN | Intelligent Network |
| IOT | Inter-Operator Tariff |
| GTT | Global Title Translation |
| IAM | Initial Address Message |
| IDP | Initial DP IN/CAP message |
| IDD | International Direct Dial |
| IMSI | International Mobile User Identity |
| IMSI-H | HPMN IMSI |
| IN | Intelligent Network |
| INAP | Intelligent Network Application Part |
| INE | Interrogating Network Entity |
| IP | Internet Protocol |
| IREG | International Roaming Expert Group |
| IRS | International Revenue Share |
| ISC | International Service Carrier |
| ISD | MAP Insert User Data |
| ISG | International Signal Gateway |
| IST | Immediate Service Termination |
| ISTP | International STP |
| ISTP-F | ISTP connected to FPMN STP |
| ISTP-H | ISTP connected to HPMN STP |
| ISUP | ISDN User Part |
| ITPT | Inbound Test Profile Initiation |
| ITR | Inbound Traffic Redirection |
| IVR | Interactive Voice Response |
| LU | Location Update |
| LUP | MAP Location Update |
| MAP | Mobile Application Part |
| MCC | Mobile Country Code |
| MCC | Mobile Country Code |
| MD | Missing Data |
| ME | Mobile Equipment |
| MGT | Mobile Global Title |
| MMS | Multimedia Message Service |
| MMSC | Multimedia Message Service Center |
| MMSC-F | FPMN MMSC |
| MMSC-H | HPMN MMSC |
| MNC | Mobile Network Code |
| MNP | Mobile Number Portability |
| MO | Mobile Originated |
| MOS | Mean Opinion Score |
| MS | Mobile Station |
| MSC | Mobile Switching Center |
| MSISDN | Mobile Station International User Directory Number |
| MSISDN-F | FPMN MSISDN |
| MSISDN-H | HPMN MSISDN |
| MSRN | Mobile Station Roaming Number |
| MSRN-F | FPMN MSRN |
| MSRN-H | HPMN MSRN |
| MT | Mobile Terminated |
| MTP | Message Transfer Part |
| NDC | National Dialing Code |
| NP | Numbering Plan |
| NPI | Numbering Plan Indicator |
| NRTRDE | Near Real Time Roaming Data Exchange |
| O-CSI | Originating CAMEL Subscription Information |
| OCN | Original Called Number |
| ODB | Operator Determined Barring |
| OPC | Origination Point Code |
| OR | Optimal Routing |
| ORLCF | Optimal Routing for Late Call Forwarding |
| OTA | Over The Air |
| OTPI | Outbound Test Profile Initiation |
| PDP | Protocol Data Packet |
| PDN | Packet Data Network |
| PDU | Packet Data Unit |
| PRN | MAP Provide Roaming Number |
| PSI | MAP Provide User Information |
| QoS | Quality of Service |
| RAEX | Roaming Agreement EXchange |
| RI | Routing Indicator |
| RIS | Roaming Intelligence System |
| RDN | Redirecting Number |
| RNA | Roaming Not Allowed |
| RR | Roaming Restricted due to unsupported feature |
| RRB | CAP Request Report Basic call state model |
| RSD | Restore Data |
| RTP | Real-Time Transport Protocol |
| SAI | Send Authentication Info |
| SC | Short Code |
| SCA | Smart Call Assistant |
| SCCP | Signal Connection Control part |
| SCP | Signaling Control Point |
| SF | System Failure |
| SG | Signaling Gateway |
| SGSN | Serving GPRS Support Node |
| SGSN-F | FPMN SGSN |
| SIM | User Identity Module |
| SIGTRAN | Signaling Transport Protocol |
| SME | Short Message Entity |
| SM-RP-UI | Short Message Relay Protocol User Information |
| SMS | Short Message Service |
| SMSC | Short Message Service Center |
| SMSC-F | FPMN SMSC |
| SMSC-H | HPMN SMSC |
| SoR | Steering of Roaming |
| SPC | Signal Point Code |
| SRI | MAP Send Routing Information |
| SRI-SM | MAP Send Routing Information For Short Message |
| SS | Supplementary Services |
| SS7 | Signaling System #7 |
| SSN | Sub System Number |
| SSP | Service Switch Point |
| STK | SIM Tool Kit Application |
| STP | Signal Transfer Point |
| STP-F | FPMN STP |
| STP-H | HPMN STP |
| TADIG | Transferred Account Data Interchange Group |
| TAP | Transferred Account Procedure |
| TCAP | Transaction Capabilities Application Part |
| VT-CSI | Visited Terminating CAMEL Service Information |
| TP | SMS Transport Protocol |
| TR | Traffic Redirection |
| TS | Traffic Steering |
| TE | Termination Ecosystem |
| TT | Translation Type |
| UD | User Data |
| UDH | User Data Header |
| UDHI | User Data Header Indicator |
| USSD | Unstructured Supplementary Service Data |
| VAS | Value Added Service |
| VIP | Very Important Person |
| VLR | Visited Location Register |
| VLR-F | FPMN VLR |
| VLR-H | HPMN VLR |
| VLR-V | VPMN VLR |
| VMSC | Visited Mobile Switching Center |
| VoIP | Voice over IP |
| VPMN | Visited Public Mobile Network |
| ATI | Access Transport Information |
| UDV | Unexpected Data Value |
| USI | User Service Information |
| WAP | Wireless Access Protocol |

Technical References, Each of which is Incorporated by Reference Herein:
GSM 902 on MAP specification
Digital cellular telecommunications system (Phase 2+)

### Mobile Application Part (MAP) Specification

(3GPP TS 09.02 version 7.9.0 Release 1998)

### GSM 340 on SMS

Digital cellular telecommunications system (Phase 2+)
Technical realization of the Short Message Service (SMS)
(GSM 03.40 version 7.4.0 Release 1998)

### GSM 378 on CAMEL,

### GSM 978 on CAMEL Application Protocol,

### GSM 379 on CAMEL Support of Optimal Routing (SOR),

### GSM 318 on CAMEL Basic Call Handling

ITU-T Recommendation Q.1214 (1995), Distributed functional plane for intelligent network CS-1,
ITU-T Recommendation Q.1218 (1995), Interface Recommendation for intelligent network CS-1,
ITU-T Recommendation Q.762 (1999), Signaling system No. 7—ISDN user part general functions of messages and signals,
ITU-T Recommendation Q.763 (1999), Signaling system No. 7—ISDN user part formats and codes,
ITU-T Recommendation Q.764 (1999), Signaling system No. 7—ISDN user part signaling procedures,
ITU-T Recommendation Q.765 (1998), Signaling system No. 7—Application transport mechanism,
ITU-T Recommendation Q.766 (1993), Performance objectives in the integrated services digital network application,
ITU-T Recommendation Q.769.1 (1999), Signaling system No. 7—ISDN user part enhancements for the support of Number Portability.

1. A communication exchange system, the system comprising:
an ecosystem of one or more operators;
a gateway for facilitating local data services for users that are one of a local subscriber and an inbound roamers of the one or more operators, wherein the gateway connects to the one or more operators via a virtual private network (VPN) tunnel; and
an interface maintaining a bi-directional connection with the gateway to exchange information related to roaming data services, and a bi-directional connection with a user via a mobile device user interface.

2. The system of claim 1, wherein the interface is a mobile application on the mobile device of the user.

3. The system of claim 1, wherein the interface allows the user to buy or trade or share data plans via the communication exchange system.

4. The system of claim 1, wherein the interface interacts with the gateway using one or more of a bidirectional Internet Protocol (IP) interface, WiFi, Cellular data, Unstructured Supplementary Service Data (USSD), and Short Message Service SMS channel, wherein either one of the interface and the gateway initiates a request or push notification.

5. The system of claim 1, wherein the interface configures a local breakout session involving the one or more operator's serving gateway and packet gateway.

6. The system of claim 5, wherein the interface configures the VPN tunnel over the local break out session to the one or more operators.

7. The system of claim 1, wherein pricing of data services for the users is governed by the gateway.

8. The system of claim 1, wherein the gateway offers free or discounted local rate data services to the users via a sponsored VPN connection.

9. The system of claim 1, wherein the user can trade data package between operators that have roaming agreement with the ecosystem of the one or more operators.

10. The system of claim 1, wherein the gateway defines an exchange rate for data plans between the one or more operators.

11. The system of claim 1, wherein the data services are sponsored by operators.

12. The system of claim 1, wherein the one or more operators have one or more of Global System for Mobile Communications (GSM), 3GSM, Long-Term Evolution (LTE), code-division multiple access (CDMA), 5th generation (5G), Wifi, Wimax and any local area or wide area technologies.

13. The system of claim 1, wherein the gateway is a cloud based electronic trading service platform that establishes connections with at least one of Home Public Mobile Networks (HPMNs) and Visitor Public Mobile Networks (VPMNs), the HPMNs and VPMNs being part of the ecosystem, and their users being registered at the gateway.

14. The system of claim 13, wherein the users are one of a local subscribers or inbound roamers of the VPMN operator that deploys the gateway.

15. The system of claim 13, wherein the data service is selected for a specific VPMN operator, the user being steered for roaming to this specific VPMN operator.

16. The system of claim 1, wherein the interface enables the users to trade data packages from the VPMN, without changing their subscriber identity module (SIM).

17. The system of claim 1, wherein the data service is activated based on user preferences as one of automatic, on-demand, threshold triggered, and top-up alert triggered.

18. The system of claim 1, wherein the interface is downloadable from an application store maintained by the communication exchange system.

19. The system of claim 1, wherein the interface enables payments related to sale or purchase of data packages, using at least one of mobile wallet, PayPal, Credit Cards, Debit Card, wire transfers, near-field communication (NFC) payments, WePay, Alipay, PayTM, and online payment systems.

20. A method of facilitating local data services for users, the method comprising:
receiving a location update message of a user at a gateway, the gateway being a part of communication exchange system having an ecosystem of one or more operators;
wherein the user is one of a local subscriber and an inbound roamer of the operator; and
establishing a virtual private network (VPN) tunnel over a data connection of the one or more operators for the user to enable local data services, the local data services being enabled via an interface that maintains a bi-directional connection with the gateway and a mobile device user interface.
